(19) United States
(12) Patent Application Publication
(10) Pub. No.: US 2008/0079836 A1
(43) Pub. Date: Apr. 3, 2008

(54) Camera, lens unit, camera body and picked-up image processing method

(76) Inventors: Hideki Nagata, Hachioji-shi (JP); Minoru Omaki, Kunitachi-shi (JP); Yu Kondo, Yamato-shi (JP); Toyokazu Mizoguchi, Kamiina-gun (JP)

Correspondence Address: KENYON & KENYON LLP, ONE BROADWAY, NEW YORK, NY, 10004, US

(21) Appl. No.: 11/903,855

(22) Filed: Sep. 24, 2007

(30) Foreign Application Priority Data
Sep. 29, 2006 (JP) 2006-267379

(51) Int. Cl. H04N 5/225

(52) U.S. Cl. 348/340; 348/373; 348/E05.022; 348/E05.024; 348/E05.025

(57) ABSTRACT

There is provided a camera, a lens unit, a camera body and a photographed image processing method that allow a good image to be readily obtained even by using the lens unit having new lens characteristics or that requires to use a new image processing algorism. The camera has the camera body, the lens unit having a photographing optical system for forming an image of an object, image pickup means for picking up the image of the object to convert it into electrical image information and image processing means for processing the image information corresponding to the lens characteristics of the lens unit. The lens unit may be removably attached to the camera body

### BACKGROUND OF THE INVENTION

1. Field of the Invention

The present invention relates to a camera, a lens unit, a camera body and a picked-up image processing method.

This application is based on Japanese Patent Application No. 2006-267379, the content of which is incorporated herein by reference.

2. Description of Related Art

Lately, because so-called digital electronic cameras in which image pick-up devices such as CCDs (Charge Coupled Device) are disposed within its body have spread, cameras equipping with an image processing CPU (Central Processing Unit) within the camera body have become widely common. The image processing CPU performs image processing of image data that is what electric image information obtained by the image pick-up devices is digitalized.

The image processing of the image data in the image processing CPU is often carried out on the basis of optical characteristics of a lens unit attached to the camera. Therefore, in case of a lens-replacing type camera in which lenses are removably attached to the camera body, the image processing in the image processing CPU must be differentiated corresponding to the optical characteristics of the respective lens units every time when the lens units are replaced in order to accurately carry out the predetermined image processing.

Then, there has been disclosed a camera that switches image processing corresponding to lens characteristics of each lens unit by giving a lens characteristic code specific to each lens unit to the lens unit (see Japanese Unexamined Patent Application, Publication No. Hei. 11-112859 for example).

Specifically, the image processing CPU reads the lens characteristic code of a lens unit when the lens unit is attached to the camera body to switch the image processing to what corresponds to the lens characteristics of the lens unit.

Meanwhile, miniaturization of not only the camera body but also the lens unit has been required lately due to the market demand on the miniaturization of cameras. However, while it is necessary to cut a number of lenses used in the lens unit to miniaturize the lens unit, it may become difficult to optically correct various aberrations caused by optical characteristics peculiar to the lens unit by combinations of lenses in this case. Therefore, there has been a demand of correcting such various aberrations of the small lens unit by image processing.

### BRIEF SUMMARY OF THE INVENTION

According to a first aspect of the invention, there is provided a camera, having

a lens unit having a photographing optical system for forming an image of an object;

image pickup means for picking up the image of the object to convert into electrical image information; and

image processing means for processing the image information, wherein

the image processing means is provided in the lens unit; and

the lens unit is removably attached to the camera body.

According to a second aspect of the invention, there is provided the lens unit having the photographing optical system for forming the image of the object to the image pickup means; and

the image processing means for processing the image information obtained by the image pickup means; and removably attached to the camera body.

According to a third aspect of the invention, there is provided a photographed image processing method having a first transmission step of transmitting the image information obtained by the image pickup means provided in the camera body to the lens unit; and

an image processing step of processing the image information within the lens unit.

### BRIEF DESCRIPTION OF THE SEVERAL VIEWS OF THE DRAWINGS

FIG. 1 is a block diagram explaining a whole configuration of a camera of a first embodiment of the invention;

FIG. 2 is a flowchart explaining operations of the camera in FIG. 1;

FIG. 3 is a block diagram explaining a whole configuration of a modified camera;

FIG. 4 is a flowchart explaining operations of the camera in FIG. 3;

FIG. 5 is a block diagram explaining a whole configuration of a camera of a second embodiment; and

FIG. 6 is a flowchart explaining operations of the camera in FIG. 5.

### DETAILED DESCRIPTION OF THE INVENTION

A camera of the present invention has a camera body and a lens unit having a photographing optical system for forming an image of an object, image pickup means for picking up the image of the object to convert into electrical image information and image processing means for processing the image information, wherein the image processing means is provided in the lens unit and the lens unit is removably attached to the camera body.

The above-mentioned camera enables one to obtain a good image to which the predetermined image processing adapted to optical characteristics of the lens unit has been implemented by the image processing means.

When the image processing carried out by the image processing means is a process for bringing about a special effect by a filtering process and the like, it is possible to select the special effect implemented to the image information by replacing the lens unit by storing an arithmetic processing method related to the predetermined special effect in the image processing means provided in the lens unit.

Thereby, it becomes unnecessary to provide large capacity storing means in the image processing means or the camera body. An operation for selecting the special effect becomes easier as compared to a method of selecting the special effect by a mode change-over switch provided on the camera body.

It is noted that the special effect described above includes the filtering process such as saturation enhancement, edge enhancement and soft rendering (soft focusing), a sepia-coloring process, a cross-screen process, a mirage process and others.

In the camera described above, preferably the image processing means has an image processing algorism specific to the lens unit.

In the camera described above, the image processing means performs the image processing to the image information on the basis of the image processing algorism specific to the lens unit. Because the image processing means is provided in the lens unit, it is possible to perform the image processing to the image information always by using the image processing algorism specific to the lens unit even when the lens unit is replaced.

In the camera described above, preferably the image processing means performs image processing for reducing or removing aberrations of optical characteristics of the photographing optical system.

According to the camera described above, the image processing means reduces or removes the various aberrations generated in the image of the object formed on the image pickup means by the photographing optical system. Accordingly, because the image processing means reduces or removes the various aberrations, even a photographing optical system having optical characteristics that generate the aberration may be used.

In the camera described above, preferably the image processing means implements the image processing by using information related to the optical characteristics specific to the photographing optical system of the lens unit to obtain the special effect.

The camera described above can implement the special effect utilizing the various aberrations to the image information for example. Therefore, the camera of the invention can obtain the effective special effect on the basis of the optical characteristics of the photographing optical system.

In the camera described above, preferably the image processing means performs the filtering process.

According to the camera described above, the image processing means performs the filtering process to the image information as the special effect. Because the image processing means is provided in the lens unit, it is possible to select whether or not the filtering process is implemented on the image information by replacing the lens unit and to implement the predetermined filtering process to the image information by selecting the lens unit to be replaced.

In the camera described above, preferably the image processing means performs at least either process of saturation enhancement, edge enhancement and soft rendering.

In the camera described above, preferably a predetermined aberration is added to the optical characteristics of the photographing optical system.

According to the camera described above, while aberrations such as blur and distortion occur in the image of the object formed by the photographing optical system on the image pickup means, a predetermined special effect may be obtained by the aberrations. Because one obtains the predetermined special effect by utilizing the aberrations, it is possible to reduce a burden of image processing in the image processing means.

A lens unit of the invention has a photographing optical system for forming an image of an object on image pickup means provided in a camera body and image processing means for image processing image information obtained by the image pickup means, and is removably attached to the camera body.

According to the lens unit described above, it is possible to readily obtain a good image on the basis of an image processing arithmetic method adapted to the optical characteristics of the photographing optical system stored in the image processing means even if the photographing optical system of the lens unit is a photographing optical system having new optical characteristics. In this case, it is not necessary to input information such as the optical characteristics to the camera body.

In the lens unit described above, preferably the lens unit further includes an image processing algorism storing section for storing image processing algorisms for the image processing, wherein the image processing means processes the image information on the basis of the image processing algorism read out of the image processing algorism storing section.

According to the lens unit described above, it is possible to obtain various optical performances and special effects by the photographing optical system having the same structure by differentiating the image processing algorism correlated to each lens unit even by different lens units having the photographing optical system whose optical characteristics are the same.

In the lens unit described above, preferably the image processing means has an image processing algorism specific to the photographing optical system.

According to the lens unit described above, the image information obtained by using the photographing optical system is processed on the basis of the image processing algorism specific to the photographing optical system. Because the image processing means is removably attached to the camera body together with the photographing optical system, it can always perform the image processing to the image information by using the image processing algorism specific to the photographing optical system.

A camera body of the invention has a casing and image pickup means for picking up an image of an object to convert into electrical image information, wherein either lens unit described above is removably attached to the casing.

According to the camera body described above, the image processing to the image information obtained by the image pickup means is performed by the image processing means in either one lens unit described above mounted to the casing. Therefore, it is not necessary to store or input the characteristics, image processing arithmetic method and others related to the replaced lens unit necessary for the image processing to the camera body by replacing the lens unit.

A picked up image processing method of the invention has a first transmitting step of transmitting image information obtained by image pickup means provided in a camera body to a lens unit and an image processing step of processing the image information within the lens unit.

According to the picked up image processing method described above, the image processing adapted to the lens unit is performed to the image information with in the lens unit (image processing step), so that even if the lens unit is replaced with a new lens unit, the image processing adapted to the new lens unit is performed to the image information within the new lens unit. Therefore, it is possible to obtain a good image by using the picked up image processing method of the invention.

In the picked up image processing method described above, preferably the picked up image processing method further includes a second transmitting step of transmitting the image information after the image processing to the camera body and a display step of displaying the image information after the image processing in the camera body.

According to the picked up image processing method described above, the image information after the image processing is displayed on the display section provided in the camera body (display step), so that the photographer can readily confirm the processed image information.

The camera, lens unit and camera body described above bring about an effect that one can readily obtain a good image even if the lens unit is replaced with a lens unit that has a new characteristic or that requires the image processing to be performed by a new algorism. They also bring about an effect that one can obtain a desirable image without increasing a burden of arithmetic operation on the side of the camera body.

Further, according to the picked up image processing method described above, it brings about an effect that one can readily obtain a good image even if the lens unit is replaced with a lens unit that has a new characteristic or that requires the image processing to be performed by a new algorism. It also brings about an effect that one can obtain a desirable image without providing large capacity storing means on the side of the camera body and without increasing a burden of arithmetic operation on the side of the camera body.

### FIRST EMBODIMENT

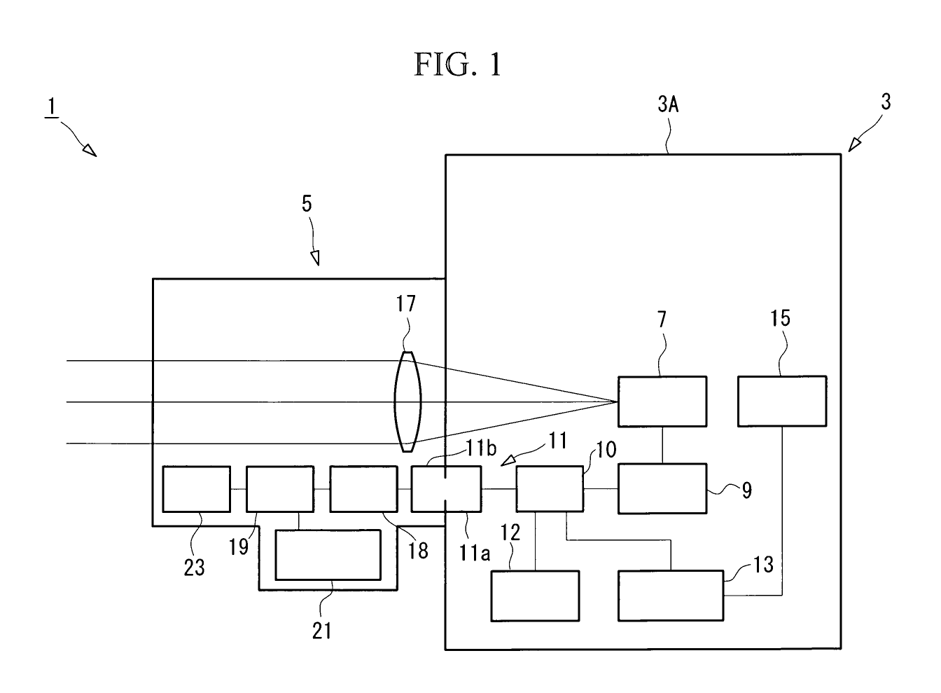

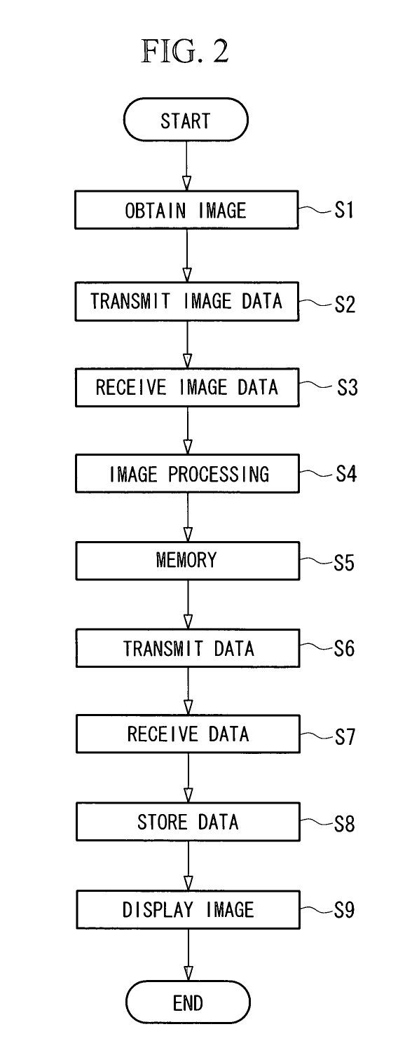

The camera of a first embodiment will be explained below with reference to FIGS. 1 and 2.

FIG. 1 is a block diagram explaining a whole configuration of a camera of a first embodiment of the invention.

The camera 1 is a digital electronic camera for photographing an image of an object by using image pickup devices such as CCD.

The camera 1 has a camera body 3 and a lens unit 5 as shown in FIG. 1.

The lens unit 5 is removably attached to a casing 3A of the camera body 3 described later via a known removing mechanism. The casing 3A is arranged so that various type of lens units 5 having different focus distances and others may be attached.

The camera body 3 holds the image pickup device 7 for picking up images of objects and removably holds the lens unit 5. As shown in FIG. 1, the camera body 3 has the casing 3A, the image pickup device (image pickup means) 7, a signal processing circuit 9, a body-side control section 10, a first communication section 11a, a display image signal processing section 13 and a displaying section (display means) 15.

The casing 3A composes an outer sheath of the camera body 3 and holds therein the image pickup device 7, the signal processing circuit 9, the body-side control section 10, the first communication section 11a, the display image signal processing section 13 and the display section 15.

The image pickup device 7 generates a picked-up image signal (electrical image information) on the basis of the object image formed on the image pickup device 7. The image pickup device 7 is disposed at position where the image of the object condensed by the lens unit 5 is formed. The picked-up image signal outputted out of the image pickup device 7 is inputted to the signal processing circuit 9. It is noted that although openly known image pickup devices such as CCD and CMOS (Complementary Metal Oxide Semiconductor) may be used as the image pickup device 7 and, the image pickup device 7 is not specifically limited to them.

The signal processing circuit 9 generates image data by carrying out a signal process such as analog-to-digital conversion to the picked up image signal outputted out of the image pickup device 7. The signal processing circuit 9 receives the picked up image signal from the image pickup device 7. The image data to which the signal processing has been carried out is outputted to the body-side control section 10.

The body-side control section 10 controls input/output of the image data before and after the image processing and is provided with a cache memory 12.

The body-side control section 10 receives the image data from the signal processing circuit 9 and image data after the image processing from a first communication section 11a. Meanwhile, the body-side control section 10 outputs the image data before the image processing to the first communication section 11a and outputs the image data after the image processing to the display image signal processing section 13.

The cache memory 12 temporarily stores image display data that has been signal-processed in the display image signal processing section 13. The image display data is input/output via the body-side control section 10 between the cache memory 12 and the display image signal processing section 13.

The first communication section 11a communicates information such as the image data between a second communication section 11b provided in the lens unit 5 and composes the communication section 11 together with the second communication section 11b.

The first communication section 11a receives the image data from the body-side control section 10 and the image data after the image processing from the second communication section 11b. The first communication section 11a outputs the image data to the second communication section 11b and the image data after the image processing to the body-side control section 10.

The display image signal processing section 13 generates the image display data by carrying signal processing to the image data after the image processing. The display image signal processing section 13 receives the image data after the image processing from the body-side control section 10 and outputs the image display data to the display section 15.

The display section 15 is composed of LCD (Liquid Crystal Display) and others and displays the image of the object on the basis of the image display data. The display section 15 receives the image display data from the display image signal processing section 13.

The lens unit 5 forms the image of the object onto the image pickup device 7 by a lens system (photographing optical system) 17 provided therein and is removably attached to the casing 3A. As shown in FIG. 1, the lens unit 5 has the lens system 17, the second communication section 11b, an image processing section (image processing means) 19, a lens characteristic storing section 21 and a memory 23.

The lens system 17 leads light from the object on a light receiving face of the image pickup device 7 to form the image.

The second communication section 11b exchanges the image data and others between the first communication section 11a provided in the camera body 3 and composes the communication section 11 together with the first communication section 11a. The second communication section 11b receives the image data from the first communication section 11a and image data after the image processing from the image processing circuit 19. The second communication section 11b outputs the image data to the image processing circuit 19 and the image data after the image processing to the first communication section 11a.

The lens unit-side control section 18 controls input/output of the image data before and after the image processing between the second communication section 11b and the image processing circuit 19.

The lens unit-side control section 18 receives the image data from the second communication section 11b and the image data after the image processing from the image processing circuit 19. Meanwhile, the lens unit-side control section 18 outputs the image data before the image processing to the image processing circuit 19 and the image data after the image processing to the second communication section 11b.

It is noted that the lens unit-side control section 18 may be a control section independent or dependent from/to the body-side control section 10. It is not what is specifically defined.

The image processing circuit 19 receives the image data from the lens unit-side control section 18 and lens characteristics specific to the lens unit 5 from the lens characteristic storing section 21. Then, on the basis of the inputted lens characteristics, the image processing circuit 19 carries out a predetermined image processing to the image data and outputs the image data after the image processing to the lens unit-side control section 18. Here, the image processing carried out by the image processing circuit 19 includes a processing of correcting optical characteristics (such as aberration characteristics that cause various aberrations like distortion) specific to the lens system 17 of the lens unit 5, image treatment and processing such as PhotoShop (Adobe Co. Registered Mark) and image processing for implementing special effect processing. Furthermore, the special effect processing among them includes filtering processes such as saturation enhancement, edge enhancement or soft focusing, sepia-coloring processing, cross screen processing or mirage processing.

Furthermore, in such camera, preferably the image processing circuit 19 has the image processing algorism specific to the lens unit. In this case, image processing is carried out on the image data inputted from the lens unit-side control section 18 in accordance to the lens unit-side control section 18. The image processing algorism used here is what obtains an arbitrary image by manipulating data on the basis of a plurality of picture elements or pixels used for representing images. Here, as the image processing algorism, it is possible to use an algorism appropriately selected from publicly known technologies such as an algorism for manipulating data for correcting the optical characteristics such as the aberration characteristics and an algorism for manipulating data to obtain the soft focusing characteristics.

It is noted that a publicly known arithmetic circuit such as CPU and DSP (Digital Signal Processor) may be used for the image processing circuit 19.

The lens characteristic storing section 21 stores information related to the lens characteristics of the lens system 17. Then, the lens characteristic storing section 21 outputs the lens characteristics to the image processing circuit 19 when the image processing circuit 19 carries out image processing. Here, the lens characteristics include, for example, various aberrations of the optical system that are image-processed by the image processing circuit 19 such as the distortion, shading and chromatic aberration of magnification of the lens system 17 in addition to control information of the body-side control section 10 for controlling the lens unit 5 such as pupil position, F number and a focal distance.

The memory 23 stores the image data after the image processing.

Note that it is possible to arrange so as to be able to obtain a good image less influenced by the various aberrations by reducing or removing the various aberrations of the lens system 17 by processing the image in the image processing circuit 19. It simplifies the structure of the lens system 17 and realizes the miniaturization of the lens unit 5.

The image processing circuit 19 may be arranged so as to be able to obtain the special effect described above by implementing the image processing to the image data inputted from the lens system 17 by using the information related to the optical characteristics specific to the lens system 17 of the lens unit 5. For example, when the lens system 17 is causing aberrations such as spherical aberration, it is possible to obtain the special effect such as the soft focusing effect by these aberrations and the image processing in the image processing circuit 19. Specifically, it is possible to add aberration characteristics that minimize the image processing for obtaining a desirable special effect intentionally to the lens system 17.

Furthermore, it is possible to arrange so as to obtain the special effect without image processing by adding the various aberrations such as the spherical aberration as the optical characteristics of the lens system 17.

It is also possible to arrange so as to obtain the special effect such as the soft focusing effect by the various aberrations such as the spherical aberration added to the optical characteristics of the lens system 17 and the image processing in the image processing circuit 19. It is possible to add the various aberrations such as the spherical aberration as the optical characteristics of the lens system 17 and to increase/decrease intensity of the special effect such as the soft focusing effect obtained by the optical characteristics by the image processing in the image processing circuit 19.

It reduces a burden of arithmetic operation of the image processing circuit 19.

It is also possible to arrange so as to obtain the special effect such as the soft focusing effect only by adding the various aberrations such as the spherical aberration as the optical characteristics of the lens system 17.

Next, operations and a photographed image processing method of the camera 1 configured as described above will be explained.

FIG. 2 is a flowchart explaining operations of the camera in FIG. 1.

When the object is photographed, the image pickup device 7 converts an image of the object formed by the lens system 17 of the lens unit 5 into image information, an electrical signal, to obtain the image information in Step S1.

The image information is inputted from the image pickup device 7 to the signal processing circuit 9. The signal processing circuit 9 carries out signal process to the image information to convert into image data that can be processed in the image processing circuit 19. The image data is inputted from the signal processing circuit 9 to the first communication section 11a via the body-side control section 10. The first communication section 11a transmits the image data to the second communication section 11b of the lens unit 5 in Step S2 (first transmitting step).

The second communication section 11b on the side of the lens unit 5 receives the image data transmitted from the first communication section 11a in Step S3.

The image data is inputted from the second communication section 11b to the image processing circuit 19 via the lens unit-side control section 18. The image processing circuit 19 carries out image processing of the image data on the basis of the lens characteristics read out of the lens characteristic storing section 21 or the image processing algorism specific to the lens system 17 in Step S4 (image processing step).

The image data after the image processing is inputted from the image processing circuit 19 to the memory 23 to be stored therein in Step S5.

When the image data stored in the memory 23 is called out, it is outputted out of the memory 23 to the second communication section 11b via the image processing circuit 19 and the lens unit-side control section 18. The second communication section 11b transmits the image data after the image processing to the first communication section 11a of the camera body 3 in Step S6 (second transmitting step).

The first communication section 11a on the side of the camera body 3 receives the image data after the image processing transmitted from the second communication section 11b in Step S7.

The image data after the image data is inputted from the second communication section 11b to the display image signal processing section 13 via the body-side control section 10. The display image signal processing section 13 converts the image data after the image processing into image display data that can be displayed on the display image signal processing section 13. The image display data is inputted to the display section 15 and is stored in the cache memory 12 in Step S8. The display section 15 displays the image-processed image stored in the cache memory 12 in Step S9 (display step).

It is noted that the cache memory 12 stores image display data related to images other than the image currently displayed on the display section 15. For example, when picked up images are displayed in order of picked up images, the cache memory 12 stores image display data and others related to an image to be displayed next after the image currently displayed in advance.

The arrangement described above enables one to obtain a desirable image processing effect without providing a change-over switch for obtaining an arbitrary image processing effect to the camera body 3 and only by replacing with a selected predetermined lens unit 5 because an effect for correcting various aberrations, an image effect or a special effect to be obtained is correlated with the predetermined lens unit.

For example, when the soft focusing effect is to be obtained by image processing, one can obtain the desirable soft focusing effect by selecting a soft focusing lens unit 5 and attaching it to the camera body 3. Therefore, it becomes possible to provide the camera whose manipulation for selecting the image processing effect is easy and intuitional.

It is also possible to readily provide the lens unit 5 having various optical characteristics because the arbitrary optical characteristic may be realized by the image processing in the image processing circuit 19 of the lens unit 5 even if the optical characteristics of the lens system 17 in the lens unit 5 are the same.

In this case, it becomes unnecessary to carry out arithmetic operations for the image processing in the arithmetic section provided in the camera body 3, reducing a processing burden of the arithmetic section on the side of the camera body 3. It is also unnecessary to provide a large capacity memory in the camera body 3 because it is not necessary to store optical characteristics of lens systems of all lens units that can be imagined to the storage section of the camera body 3 in advance.

As a case when an image processing arithmetic method adapted to optical characteristics of a new lens system 17 or an image processing arithmetic method corresponding to an image processing algorithm adapted to the optical characteristics, there is a case of using a lens system that causes a large aberration to be corrected, e.g., large distortion (about 20% to 30%).

When the occurrence of aberration of the lens system, i.e., the distortion here, is small (around 5%), it was possible to make common the process for correcting the distortion of the lens system and to process a plurality of image data picked up by different lens units by one image processing algorism.

However, it was difficult to make common the process for correcting the distortion of less in a plurality of lens units in case of a lens system having a large distortion was difficult to appropriately process image data obtained by using different lens units by one image processing algorism.

Specifically in case of a small lens unit in which a number of lenses is limited, it is difficult to optically correct the occurrence of the various aberrations caused by the optical characteristics specific to the lens unit as described above by a combination of the lenses and the occurrence of the various aberrations may increase. Even in such a case, the image processing circuit 19 provided in the lens unit 5 can store the image processing algorism adapted to the lens unit, so that it provides a good image.

### MODIFICATION OF FIRST EMBODIMENT

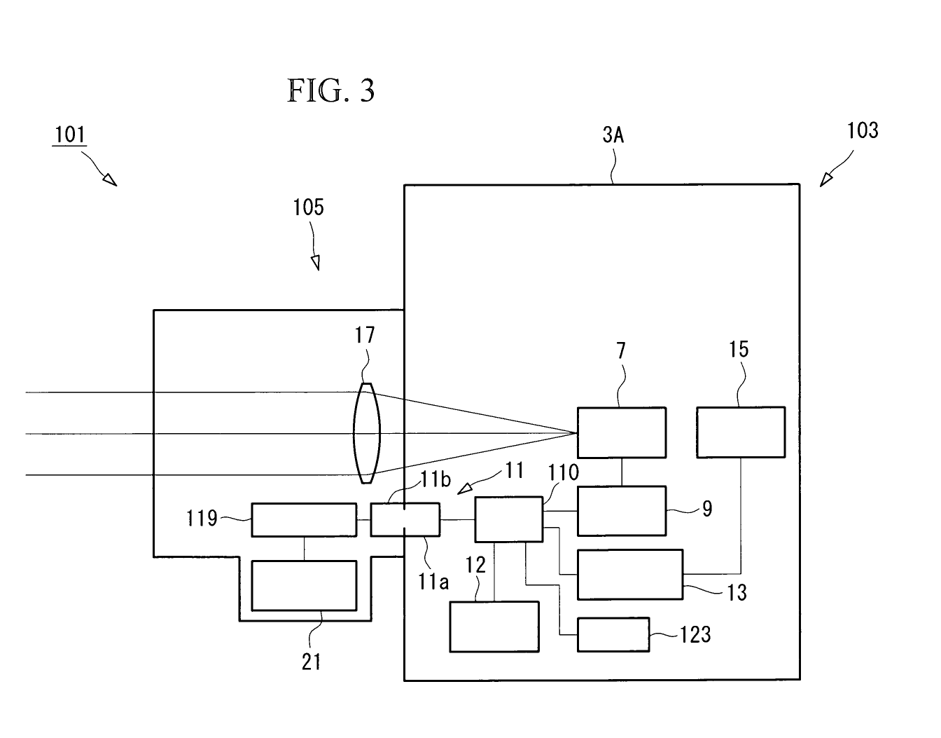

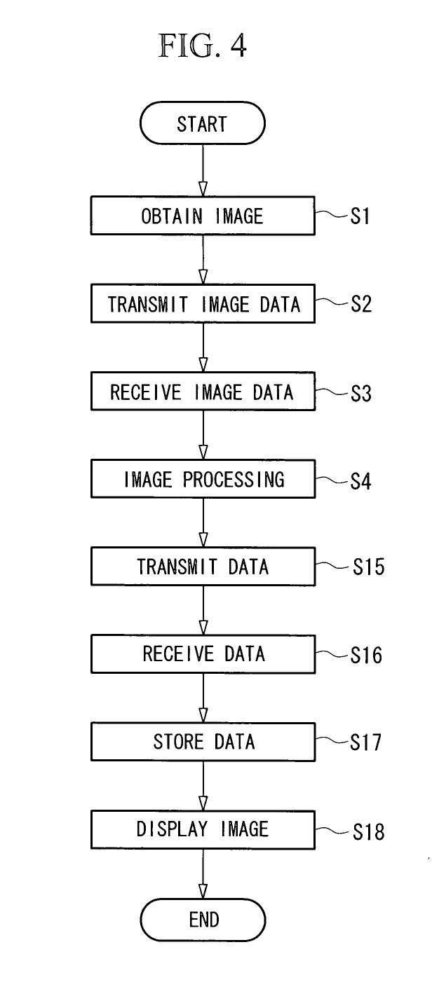

Next, a modified example will be explained with reference to FIGS. 3 and 4.

Although the basic structure of the camera is the same with that of the first embodiment, the memory is provided on the side of the camera body. Accordingly, only the memory and peripheral parts thereof will be explained in this modified example and the same components will be denoted by the same reference numerals and their explanation will be omitted here.

FIG. 3 is a block diagram explaining a whole configuration of the modified camera.

The camera 101 is a digital electronic camera for photographing an image of an object by using image pickup devices such as the CCD similarly to that in the first embodiment.

As shown in FIG. 3, the camera 101 has a camera body 103 and a lens unit 105.

The camera body 103 holds the image pickup device 7 for picking up images of objects and removably holds a lens unit 105. As shown in FIG. 3, the camera body 103 has the casing 3A, the image pickup device 7, the signal processing circuit 9, a body-side control section 110, the first communication section 11a, the display image signal processing section 13, a display section 15 and a memory 123.

The body-side control section 110 controls input/output of the image data before and after the image processing. The body-side control section 110 is provided with the cache memory 12.

The body-side control section 110 receives the image data from the signal processing circuit 9 and image data after the image processing from the first communication section 11a. Meanwhile, the body-side control section 110 outputs the image data before the image processing to the first communication section 11a and outputs the image data after the image processing to the display image signal processing section 13.

The image data after the image processing is input/output between the memory 123 and the body-side control section 110.

The memory 123 stores the image data after the image processing. The memory 123 receives the image data after the image processing from the first communication section 11a and outputs the image data after the image processing to the display image signal processing section 13.

The memory 123 receives the image data after the image processing from the first communication section 11a via the body-side control section 110.

The display image signal processing section 13 receives the image data after the image processing from the memory 123 via the body-side control section 110.

The lens unit 105 has the lens system 17, the second communication section 11b, an image processing section (image processing means) 119 and the lens characteristic storing section 21.

The image processing section 119 has an image processing algorism specific to the lens unit 105 and implements image processing to the image data on the basis of the image processing algorism and the lens characteristics of the lens system 17 of the lens unit 105. The image processing section 119 receives the image data from the second communication section 11b and the lens characteristics from the lens characteristic storing section 21. The image processing section 119 outputs the image data after the image processing to the second communication section 11b.

Next, operations and a photographed image processing method of the camera 101 constructed as described above will be explained.

FIG. 4 is a flowchart explaining operations of the camera in FIG. 3.

The operations from Step S1 in which the object image is picked up by the image pickup device 7 in photographing the object to Step S4 in which the image processing of the image data is carried out by the image processing section 119 are the same with those in the first embodiment, so that their explanation will be omitted here.

The image data after the image processing is outputted from the image processing section 119 to the second communication section 11b. Then, the second communication section 11b transmits the image data after the image processing to the first communication section 11a of the camera body 3 in Step S15 (second transmitting step).

The first communication section 11a receives the image data after the image processing transmitted from the second communication section 11b in Step S16.

The image data after the image processing is inputted from the second communication section 11b to the memory 123 via the body-side control section 110 to be stored in the memory 123 in Step S17.

When the image data stored in the memory 123 is called out, it is inputted from the memory 123 to the display image signal processing section 13 via the body-side control section 110. The display image signal processing section 13 converts the image data after the image processing into image display data that can be displayed on the display section 15. The image display data is then inputted to the display section 15 and the display section 15 displays the corrected image of the object in Step S18 (display step).

The lens unit 5 has the lens characteristic storing section 21 and the image processing circuit 19 implements image processing to the image data on the basis of the lens characteristics stored in the lens characteristic storing section 21 in the first embodiment, the image processing circuit 19 may be made common among respective different types of lens units.

It is noted that when the image processing circuit 19 is arranged so as to carry out image processing applicable only to a specific lens unit, e.g., image processing specialized to the lens system 17, the lens characteristic storing section 21 may be omitted.

### SECOND EMBODIMENT

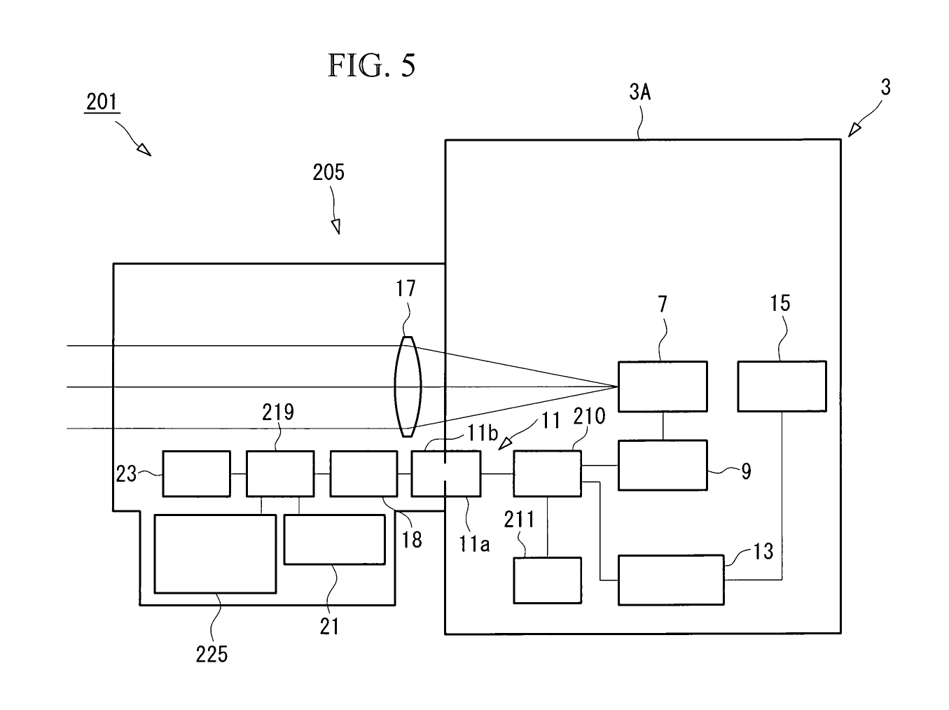

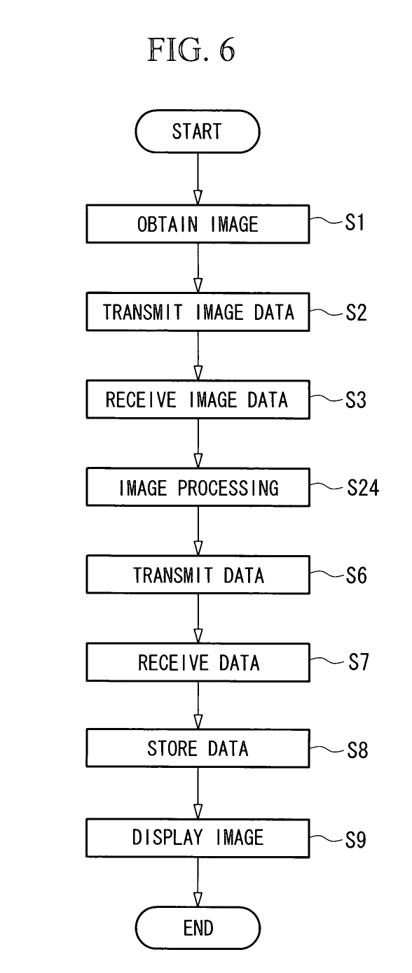

Next, a second embodiment will be explained with reference to FIGS. 5 and 6.

While the basic structure of the camera is the same with that of the first embodiment, the structure of the lens unit of the present embodiment is different from that of the first embodiment. Therefore, only the lens unit and peripheral parts thereof will be explained with reference to FIGS. 5 and 6, and the explanation of the other components will be omitted here.

FIG. 5 is a block diagram explaining a whole configuration of a camera of the second embodiment.

It is noted that the same components with those in the first embodiment are denoted by the same reference numerals and their explanation will be omitted here.

The camera 201 is a digital electronic camera for photographing the image of the object by using image pickup devices such as the CCD similarly to that in the first embodiment.

As shown in FIG. 5, the camera 201 has the camera body 3 and a lens unit 205.

The camera body 3 holds the image pickup device 7 for picking up images of objects and removably holds the lens unit 5. As shown in FIG. 5, the camera body 3 has the casing 3A, the image pickup device (image pickup means) 7, the signal processing circuit 9, a body-side control section 210, the first communication section 11a, the display image signal processing section 13 and the displaying section (display means) 15.

The body-side control section 210 controls input/output of the image data before and after the image processing.

The body-side control section 10 receives the image data from the signal processing circuit 9 and image data after the image processing from a first communication section 11a. Meanwhile, the body-side control section 210 outputs the image data before the image processing to the first communication section 11a and outputs the image data after the image processing to the display image signal processing section 13.

An inputting section is a section through which a photographer inputs parameter values and others specifying an image processing method in an image processing section 219 to the body-side control section 210 for example and the inputted parameter values are outputted to the body-side control section 210.

It is noted that the inputting section 211 may be provided in the body-side control section 210 as described above or may be provided in a lens unit-side control section 18 described later, i.e., the location where it is provided is not specifically limited.

The lens unit 205 is attached removably to the casing 3A of the camera body 3. The camera body 3 is arranged so that different types of lens units 205 may be attached thereto.

The lens unit 205 is what forms the image of the object on the image pickup device 7 by the lens system 17 provided therein and is removably attached to the camera body 3. As shown in FIG. 5, the lens unit 205 has the lens system 17, the second communication section 11b, the lens unit-side control section 18, an image processing section (image processing means) 219, the lens characteristic storing section 21, the memory 23 and an image processing algorism storage section 225.

The image processing section 219 implements image processing to the image data on the basis of the image processing algorism specific to the lens unit 205 and the lens characteristics. Similarly to the first embodiment, the image processing section 219 receives the image data and lens characteristics and the image processing algorism from the image processing algorism storing section 225. the image data after the image processing is input/output between the image processing section 219 and the memory 23.

The image processing algorism storing section 225 stores predetermined image processing algorisms. The image processing algorisms stored here include an algorism for executing processing of correcting optical characteristics (such as aberration characteristics that cause various aberrations like distortion) specific to the lens system 17 of the lens unit 5, an algorism for executing image treatment and processing such as PhotoShop and an algorism for carrying out the image processing for implementing special effects. Furthermore, the algorism for carrying out the special effect processing among them includes algorisms for carrying out filtering processes such as saturation enhancement, edge enhancement or soft focusing, sepia-coloring processing, cross screen processing or mirage processing.

According to the present embodiment, the image processing algorism storing section 225 stores two algorithms of executing the process for correcting the optical characteristics specific to the lens system 17 of the lens unit 205, e.g., aberration characteristics that cause various aberrations such as distortion, and of executing the image processing for obtaining the soft focusing effect.

Next, operations and a photographed image processing method of the camera 201 constructed as described above will be explained.

FIG. 6 is a flowchart explaining operations of the camera in FIG. 5.

The operations carried out from Step S1 in which the object image is picked up by the image pickup device 7 in photographing the object to Step S3 in which the second communication section 11b receives the image data are the same with those in the first embodiment, so that their explanation will be omitted here.

The image data is inputted from the second communication section 11b to the image processing section 219 via the lens unit-side control section 18. The image processing section 219 performs image processing of the image data on the basis of the image processing algorism read out of the image processing algorism storing section 225 and the lens characteristics read out of the lens characteristic storing section 21 in Step S24 (image processing step). The present embodiment enables one to appropriately select the image processing of obtaining a good image by correcting the optical characteristics of the lens system 17 such as the various aberrations and the image processing of obtaining the soft focusing effect. Here, the selection of the image processing for the correcting process described above and the image processing for obtaining the soft focusing effect is carried out by selecting algorisms for executing the respective processes stored in the image processing algorism storing section 225 from the inputting section 211. The operations carried out after the image processing of the image data by the image processing section 219 are the same with those of Step S6 to Step S9 in FIG. 2, so that their explanation will be omitted here.

It is noted the parameter values specifying the processing method in the image processing section 219 may be changed from the inputting section 211. That is, it is possible to change a degree of correction of the various aberrations and weakness of the filtering effect and retouching effect by changing the parameter values.

According to the configuration described above, the image processing section 219 performs the appropriate image processing to the image information on the basis of the image processing algorism read out of the image processing algorism storing section 225 that is attached/removed to/from the camera body 3 in the same time with the lens unit 205.

Therefore, because the image processing algorism storing section 225 in which the image processing algorism concerning to the optical characteristics of the lens system 17 is replaced together with the image processing section 219 when the lens unit 205 is replaced, one can obtain the desirable image processing effect just by replacing the lens unit 205.

It is also possible to obtain various optical performances and special effects by the lens unit 205 having the lens system 17 having the same structure by differentiating the image processing algorisms correlated to the respective lens units even in the different lens units 205 having the lens system 17 whose optical characteristics are the same.

It is noted that the lens unit 205 has the image processing algorism storing section 225 and the lens characteristic storing section 21 and the image processing section 219 performs the image processing to the image data on the basis of the image processing algorism stored in the image processing algorism storing section 225 and the lens characteristics stored in the lens characteristic storing section 21 in the second embodiment described above. Such configuration allows the image processing section 219 and the image processing algorism storing section 225 to be made common among different types of lens units.

It is noted that when the image processing section 219 and the image processing algorism storing section 225 are arranged so as to perform the image processing applicable only to a specific lens unit, e.g., the image processing specialized for the lens system 17, the lens characteristic storing section 21 may be omitted.

The first and second embodiments may be arranged so that the control section judges whether or not the lens unit removably attached to the camera body is a lens unit that is capable of processing image information outputted out of the image pickup means of the camera body and so as to indicate its result of judgment for the user on the display section of the camera body. When the attached lens unit is a lens unit that is capable of processing the image information, names and contents of its image processing may be specifically displayed for the user on the display section of the camera body.

Still more, when the lens unit attached to the camera body is a lens unit capable of processing the image information, the user may set a prohibit mode for prohibiting a part or whole of image processing carried out by the image processing section mounted in the lens unit by carrying out predetermined manipulations.

What is claimed is:

1. A camera, comprising:
a camera body; and
a lens unit having;
a photographing optical system for forming an image of an object;
image pickup means for picking up the image of the object to convert into electrical image information; and
image processing means for processing the image information, wherein
the image processing means is provided in the lens unit; and
the lens unit is removably attached to the camera body.

2. The camera according to claim 1, wherein the image processing means comprises an image processing algorism specific to the lens unit.

3. The camera according to claim 1, wherein the image processing means performs image processing for reducing or removing aberrations of optical characteristics of the photographing optical system.

4. The camera according to claim 1, wherein the image processing means performs a filtering process.

5. The camera according to claim 1, wherein the image processing means performs at least either process of saturation enhancement, edge enhancement and soft rendering.

6. The camera according to claim 4, wherein a predetermined aberration is added to the optical characteristics of the photographing optical system.

7. A lens unit, comprising:
a photographing optical system for forming an image of an object on image pickup means provided in a camera body; and
image processing means for image processing image information obtained by said image pickup means; and
removably attached to the camera body.

8. The lens unit according to claim 7, further comprising an image processing algorism storing section for storing image processing algorisms for the image processing; wherein
the image processing means processes the image information on the basis of the image processing algorism read out of the image processing algorism storing section.

9. The lens unit according to claim 7, wherein the image processing means has an image processing algorism specific to the photographing optical system.

10. A camera body, comprising:
a casing; and
image pickup means for picking up an image of an object to convert into electrical image information; wherein
the lens unit described in claim 7 is removably attached to the casing.

11. A picked up image processing method, comprising:
a first transmitting step of transmitting image information obtained by image pickup means provided in a camera body to a lens unit; and
an image processing step of image processing the image information within the lens unit.

12. The picked up image processing method according to claim 11, further comprising:
a second transmitting step of transmitting the image information after the image processing to the camera body; and
a display step of displaying the image information after the image processing in the camera body.
